(19) United States
(12) Patent Application Publication
(10) Pub. No.: US 2007/0202343 A1
(43) Pub. Date: Aug. 30, 2007

(54) COLOR EFFECT LAYER SYSTEM AND COATINGS BASED ON PHOTONIC CRYSTALS AND A METHOD FOR THE PRODUCTION AND USE THEREOF

(76) Inventors: Dirk Sprenger, Stadecken-Elsheim (DE); Martin Letz, Mainz (DE); Steffen Reichel, Mehlingen (DE); Wolfgang Mannstadt, Munster-Sarmsheim (DE); Peter Blaum, Weiterstadt (DE)

Correspondence Address: TAYLOR & AUST, P.C., 142 SOUTH MAIN STREET, P. O. BOX 560, AVILLA, IN, 46710, US

(21) Appl. No.: 11/677,146

(22) Filed: Feb. 21, 2007

(30) Foreign Application Priority Data
Feb. 28, 2006 (DE) 10 2006 011 154.0
Aug. 1, 2006 (DE) 10 2006 035 806.6

(51) Int. Cl. B32B 17/06

(52) U.S. Cl. 428/432; 428/701

(57) ABSTRACT

The invention relates to a color effect layer system, including: a carrier substrate selected from glass or glass-ceramics, at least one layer of spheres, particularly preferred at least 50 layers, more preferred 50 to 100 layers, including filled or not filled cavities/honeycombs, in the form of a porous material composite of a crystal-like superstructure or an inverse crystal-like superstructure having a three-dimensional periodic or substantially periodic configuration in the order of magnitude of the wavelength of visible light, wherein the sphere diameters and optionally the cavity/honeycomb diameters have a very strict distribution. In addition to the excellent optical properties, the coating systems also have sufficient mechanical stability.

### BACKGROUND OF THE INVENTION

1. Field of the Invention

The invention relates to a color effect layer system and coatings based on photonic crystals and to a method for the production and use thereof.

2. Description of the Related Art

It is known that paints serve as color effect coatings, wherein the color pigments contained therein must be flaky and must be subjected to vapor deposition to increase the color effects and particularly to achieve an iridescent optical effect in conjunction with the nacrous effect. Paint coatings with high light dynamics, meaning paints with gloss effects or such conveying a color impression that is dependent on the incident light and the viewing direction, are characterized by a particularly complex production process and by a limitation when it comes to the design of the color effects.

One possibility to color a surface with applying pigments is to use interference layer systems, which are characterized by wavelength-selective reflection. However, interference layer systems are complex to produce because each layer must be applied or vapor-deposited separately, and furthermore the layer sequence of an interference layer system, which sequence can alternate only in one direction, only allows certain color effects to be produced.

One alternative is photonic crystals. Photonic crystals were mentioned for the first time in 1972 (V. P. Bykov, “Spontaneous emission in a periodic structure”, Sov. Phys. JETP 35 269 (1972)) and at the end of the 1980s their optical properties were calculated in theory (E. Yablonovitch, “Inhibited Spontaneous Emission in Solid-State Physics and Electronics” Phys. Rev. Lett. 58, 2059-2062 (1987); S. John, “Strong Localisation of Photons in Certain Disordered Dielectric Superlattices” Phys. Rev. Lett. 58, 2486-2489 (1987)). Since that time, photonic crystals have become an actively researched field. The fascination with this technology lies in the possibility to design materials with very specific optical properties. 3D and 2D photonic crystal structures are meanwhile extensively discussed in literature.

Photonic crystals are materials with a crystal-like superstructure, which crystals have, for example, a photonic band gap, meaning forbidden or inaccessible energy states for photons, which are areas of forbidden energy in which electromagnetic waves cannot propagate within the crystal. In a certain respect, photonic crystals can therefore be considered “optical semiconductors”, meaning the optical equivalent of electronic semiconductors. In photonic crystals, however, no band gap must be present because a highly angle and wavelength-dependent reflectivity is already sufficient.

Photonic crystals are characterized by a regular, three-dimensional periodic lattice structure, including regions with strongly fluctuating refractive indices. The unique optical properties are achieved in a three-dimensional, spatially periodic configuration of materials of high and low refractivity with a lattice periodicity in the order of magnitude of the wavelength of the visible spectrum. Structures of this type are found as the inanimate kind and are known above all in precious stones, for example opals, the iridescence of which is also based on the diffraction of light on photonic crystals. Opals are made of a periodic configuration of silicate spheres, which are embedded in a hydrous silicate matrix. The varying water contents produce the periodic change of the refractive index that is important for generating the colors. Opals have no band gap, but have the highly angle and wavelength-dependent reflectivity referred to above.

These optical materials are interesting because switch functionalities and light guide functionalities can be incorporated. The special optical properties of artificially produced photonic crystals are used particularly in the telecommunications field, especially with respect to applications relating to optical telecommunications engineering and nano-optics.

In the meantime, several methods for producing materials with crystal-like superstructures, particularly photonic crystals, became known. The methods are either based on a self-organization of the spheres that form the photonic crystal or on the production of a perform, a so-called template. The template is the “positive image” of the structure, which is dissolved or removed in a subsequent step, leaving the image/frame of an inverse structure (negative). So as to produce specific desired materials with special macromolecular properties, the frame or honeycomb structure produced with the methods referred to above can, if needed, also be filled with suitable, high temperature resistant, highly refractive substances.

A template may be produced, for example, through the sedimentation of polymer or quartz spheres, which are initially present in a liquid. The difficulty encountered here is to evaporate the liquid so slowly that the spheres align in a regular lattice. After pouring in the photonic material, the so-called infiltration, and after removing the template matrix, the desired structure is obtained, e.g. an inverted opal. As far as the production of templates is concerned, which may serve as performs for forming crystal-like superstructures of solids with a higher refractive index and which are referred to as inverse opals, reference is made to “From Opals to Optics: Colloidal Photonic Crystals” by Vicky L. Colvin, MRS Bulletin/August 2001, pgs. 637-641. For materials with effects with transparent colored layers that are produced for decorative purposes and are intended to imitate opals, reference is made to EP 215 324 A2. JP 2004098414 A describes the production of ornamental materials with reverse opal structures. The production of synthetic opals is described in general terms in WO 94/16123, US 2001/0020373 A1 and U.S. Pat. No. 6,260,388 B1.

Also the production using the so-called sol-gel infiltration by way of a sol-gel method is known, wherein in a first stage of the method a sol is formed and the photonic crystal is obtained by drying the gel, meaning the liquid component is removed from the cavities of the gel.

With respect to sol-gel methods, which are used during the sol-gel infiltration of a perform for producing glasses, glass-ceramics, ceramics and composites, reference is made to the following documents:

Prospects of Sol-Gel-Processes, by Donald R. Ulrich, Journal of Non-Crystalline Solids 100 (1988), pgs. 174-193;

Charakterisierung von Si0₂-Gelen und -Gläsern, die nach der Alkoxid-GelMethode hergestellt wurden (Characterization of SiO₂ Gels and Glasses which were prepared by the alkoxide-gel method), by Wolfram Beier, Martin Meier and Günther Heinz Frischat, Glastechnische Berichte (Glass Reports) 58 (1985), No. 5, pgs. 97-105; and

Glaschemie (Glass Chemistry) by Werner Vogel, Springer Publishing Co., Berlin, Heidelberg, New York, 1992, pgs. 229-233.

The disclosure contents of all the references mentioned above are hereby included to the full extent in the disclosure content of the present application.

Templates or photonic crystals are frequently produced using microlithographic structuring methods. One example of this is the field of holographic lithography. The starting point here is a light-sensitive photoresist. When superimposing four laser beams at certain angles at the same time, a three-dimensional modulation of the light intensity is produced at the order of magnitude of the wavelength of the laser. If in this region the paint is now exposed to light, the structure can be translated into the paint. The produced three-dimensional structures excel above all due to their perfect periodicity.

A further possibility for producing photonic crystals is to use micromechanical methods, wherein a silicon wafer is coated with silicon dioxide, for example, uniform troughs are cut in it and filled with polysilicon. The surface is then evenly polished and covered again with SiO₂ and uniform polysilicon strips are structured therein, however they extend at a right angle to the strips in the layer beneath. By repeating this process a number of times, it is possible to produce crosswise double layers. The SiO₂, as the support material, may be dissolved out with hydrogen fluoride, resulting in a cross-lattice structure made of polysilicon with regular cavities (see R. Sietmann, “Neue Bauelemente durch photonische Kristalle (New elements through photonic crystals)”, Funkschau 26, 1998, pg. 76-79, or “Silicon-based photonic crystals” by Albert Birner, Ralf B. Wehrspohn, Ulrich M. Gösle and Kurt Busch, Advanced Materials, 2001, 13, No. 6, pgs. 377-388).

In an alternative method, the capillary forces at the meniscus of a colloidal solution and of a substrate are used to draw colloids into densely packed structures by way of self-organization.

In the known methods for producing highly organized crystals through self-organization, the problem was that, during drying of the colloidal superstructures, the fluid in the cavities could only be drawn off with difficulty and, in particular, only over a very long period of time.

WO 2004/024627 describes a method for producing such photonic crystals, which avoids this problem through hypercritical drying. Hypercritical drying results in a more rapid removal of the liquid from the crystal-like superstructures. Furthermore, damage to the structure, particularly to the inverse structures, is prevented during drying.

Furthermore, the state of the art describes photonic crystals produced through self-organizing processes, however which are only conditionally suited for coating an area measuring at least 1 cm in size and with a layer thickness of ≧1 μm, because the sub-micrometer crystal structure experiences such high mechanical loads as a result of the removal of the dispersion fluid of the original colloidal system that disturbances arise in the lattice or the layer detaches locally from the substrate. So as to avoid this mechanical problem, spherical colloids have become known from U.S. Pat. No. 6,262,469, which form self-organizing three-dimensional structures that are subjected to a further treatment step in order to form a material connection in the shape of a neck between adjoining spheres. These connections result in greater mechanical stability of the material.

Furthermore, U.S. Pat. No. 6,139,626 describes a method for producing three-dimensionally structured materials through self-organization while using a template, wherein synthetic opals serve as the templates and the pores of the template are filled with colloidal nanocrystals. For the production, annealing may be carried out at elevated temperatures and increased pressure, resulting in partial melting of the spheres, which in turn produces the neck formation.

The neck-shaped connections, however, greatly interfere with the optical properties of the photonic crystal when used in color effect layers because the strict periodicity of the filter is negatively influenced. Since the growth of this crystal structure generally cannot be controlled with sufficient precision, the results are a deviation from the symmetrical structure and a distortion of the lattice, clearly reducing the color effects of the coating.

What is needed in the art is to provide color effect layer systems and color effect coatings based on photonic crystals, which systems and coatings have sufficient mechanical stability and, depending on the application, also sufficient thermal stability to be suited for the corresponding applications. The necks considered necessary until now with photonic crystals according to the state of the art for the purpose of holding the superstructures together and for guaranteeing mechanical stability may be eliminated. Furthermore, no impairment whatsoever of the intensive formation of the color effect as well as of the color dynamics due to a deviation from the symmetrical structure or a distortion of the lattice shall exist. The color effect coating shall in particular be suited for applications on large-surface and arbitrarily shaped substrates, also at varying thermal loads.

### SUMMARY OF THE INVENTION

The present invention provides, in one aspect of the invention, a color effect layer system including a carrier substrate selected from glass or glass-ceramics; and at least one layer of spheres, particularly preferred at least 50 layers, more preferred 50 to 100 layers, including filled or not filled cavities/honeycombs, in the form of a porous material composite of a crystal-like superstructure or an inverse crystal-like superstructure having a three-dimensional periodic or substantially periodic configuration in the order of magnitude of the wavelength of visible light, wherein the sphere diameters and optionally the cavity/honeycomb diameters have a very narrow distribution.

The present invention also relates to the coating as such.

By generating a periodic or substantially periodic structure on the surface of a glass or glass-ceramics with three-dimensional periodicity, which is in the order of magnitude of the wavelength of visible light, a color effect is produced. In the case of white illumination, a colorful iridescent color effect is produced, which depends on the observation angle and the angle at which the material is illuminated. The structures according to the present invention have no band gap, and the optical properties rather result from a highly angle and wavelength-dependent reflectivity.

Within the scope of the present invention, “crystal-like superstructures” with the aforementioned higher order periodicity or substantial periodicity in the order of magnitude of the wavelength of visible light shall be understood as the above-described system of photonic crystals. In the present invention, a three-dimensional periodicity shall apply, meaning a repeating two-dimensional configuration, which is present on the longitudinal scale (x- and y-directions of a Cartesian system), wherein the alternating composite and/or layer sequence is repeated periodically (z-axis) and results in a three-dimensional periodicity. In other words, the periodicity is repeated within a layer of spheres and, where applicable, within further layers of spheres provided thereon.

Surprisingly, by setting the sphere size distribution within extremely strict limits it is possible through the present invention to produce a porous coating material with suitable mechanical stability, which material produces a color effect, without having to resort to the neck-shaped material connections between spheres that interfere with the optical properties of the coating. As a result, a stabilization of the crystal-like/inverse superstructures through neck-shaped material connections between the spheres is foregone, a high-quality color effect coating, meaning having high light dynamics, is produced, and nevertheless layer systems and/or coatings are obtained, which offer sufficient mechanical stability. According to the present invention, it is in particular also possible to provide a thermally stable coating.

By using substantially equal sphere sizes and optionally substantially equivalent cavities/honeycombs, improved sorting and/or stacking of the spheres is possible, resulting in improved mechanical stability.

So as to achieve a very narrow distribution of the sphere sizes, sphere sizes are used, which deviate from each other only slightly in terms of the sphere diameter. For example, the sphere size distribution is selected such that the standard deviation of the sphere radius divided by the mean value of the sphere radius Δr/ r̅=\sqrt{r̅²̅− r̅²}/ r̅ (the dash denoting that a mean value is produced) is <0.1, preferably <0.03, particularly preferred <0.001.

The production of such narrow sphere size distributions is known to the person skilled in the art.

According to the present invention, the spheres are advantageously present in a size in the range of 10 nm to 10 μm, meaning in a range that is typical for photonic crystal structures.

The number of layers present depends on the desired optical properties. Advantageously, according to the present invention a step of the refractive index may be provided in the color effect coating (hereinafter also referred to as “structure”). The refractive index denotes the refraction of the light when passing into a transparent material and it is the ratio of the phase velocity of the light in a vacuum to its phase velocity in the respective medium, so that a step in the refractive index means a significant difference in the refractive indices of the available media and/or materials. In particular, the number of layers of the spheres may also depend on the step of the refractive index. The greater the step of the refractive index, the fewer layers are required. Preferably at least 50 to 100 or more layers of spheres with periodic or substantially periodic configuration are produced. It is possible to have approximately 500 layers of spheres. Suitable embodiments may also have approximately 10 to approximately 200 layers of spheres, preferably about 20 to about 100 layers of spheres in the appropriate configuration. Particularly preferred are embodiments with at least 30 to 80 layers of spheres. This, as has been explained above, depends on the step of the refractive index.

According to the present invention, a composite may include a plurality of layers of spheres. As has been described above, up to 500 layers of spheres may be present in one composite. It is also possible, however, to apply a plurality of composites on top of each other. These may differ from each other, for example, in terms of the periodicity, meaning the configuration of the spheres, which is also associated with the sphere size and/or distribution and the size and/or distribution of the cavities reflected in the distance d. “Periodicity” within the scope of the present invention means a certain unit of spheres, the configuration of which is repeated continuously in one layer and may optionally be repeated in further layers.

According to the present invention, a composite may accordingly include a plurality of layers of spheres, the layer thickness of which therefore advantageously is in the range of about 1 μm to about 100 μm, particularly about 10 μm to about 50 μm. It is particularly preferred if the layer thickness is in the range of 1 to 10 μm, even more preferred of 1 to 8 μm, especially preferred 1 to 5 μm, in particular 2 to 5 μm.

The composites or coatings according to the present invention do not have to be layers or coatings across the entire surface, but may also be applied across part of the surface. They may be present, for example, also as decor or design elements. “Decor” shall mean a structured composite across part of or across the entire surface, which composite is applied, for example, to the top and/or bottom of a carrier or substrate. The layer thickness of a decor most preferably ranges between 1 and 5 μm.

It is preferable if all spheres of one layer have the same size with extremely narrow distribution, even more preferred a plurality of layers of spheres have the same sphere size with extremely narrow distribution, particularly preferred all spheres of all layers of a porous material composite have the same sphere size with extremely narrow distribution. It also possible to have two, three or more composites with the same number or different numbers of layers of spheres and optionally with different periodicity.

According to an embodiment of the present invention, the cavities between the spheres are also of importance. It is preferable if accordingly the characteristic dimensions of the different periodically arranged cavities/honeycombs of the crystal-like or inverse crystal-like superstructure largely agree with each other and are within a very narrow distribution, wherein the lattice periodicity of the refractive index is preferably selected such that the maximum of the first refractive order for reflected light of at least one visible wavelength is in an angle range between 0 and 180 degrees. The angle here is defined such that 0 degrees means precise back-scattering in exactly the opposite direction of the incident light beam and 90 degrees means scattering at a right angle to the incident light.

Experiments showed that it is particularly advantageous if one or more layers of spheres of a crystal-like superstructure or of an inverse crystal-like superstructure with periodic or substantially periodic configuration have a periodic distance d in the range of 100 nm≦d≦3000 nm, particularly 300 nm≦d≦1000 nm. Here, the distance d denotes the distance between the centers of two adjoining spheres, so that d may correspond, for example, to the sphere diameter, however in the case of corresponding cavities it also may clearly deviate from this. By varying the distance d, it is also possible to influence the optical effects of the structures. Optical effects, such a deepening of the color impression, may be increased by providing loose structures. Loose structures means, for example, high volume percentages in the structures, which are filled, for example, with media with a lower refractive index (for example air) or with media with a particularly high refractive index (for example TiO₂, ZnS, ZrO₂, Ge, Si, GaP, Sb₂S₃, SnS₂, CdS and more).

Loose structures may also be obtained, for example, by selecting a larger distance d, such as a distance d in the range or 2r (r being sphere radius) to 5r. A further possibility to increase the optical effects is to use inverse structures in combination with materials that have a high refractive index. These materials are selected, for example, from TiO₂, ZnS, ZrO₂, Ge, Si, GaP, Sb₂S₃, SnS₂, CdS and mixtures thereof. The spaces (cavities/honeycombs) between the spheres (which are packed densely, for example), such as polymer or SiO₂ spheres, are filled with a material having an extremely high refractive index, such as TiO₂, ZnS, ZrO₂ Ge, Si, GaP, Sb₂S₃, SnS₂, CdS and mixtures thereof and subsequently the spheres, such as polymer or SiO₂ spheres, are moved by etching.

A high difference in the refractive indices between the structure and the filled or unfilled cavity is accordingly an important aspect of the present invention; in other words, the cavities and/or honeycombs between the spheres may be filled or not and the refractive index of the filling material or lacking material together with the refractive index of the sphere material influences the optical properties of the layer(s).

According to the present invention, for example plastics, amorphous materials and/or glass have proven advantageous materials for the spheres. The plastics that are used are not particularly limited within the scope of the invention. The following are mentioned by way of example: polystyrene (PS), polymethyl methacrylate (PMMA), silicon, Teflon and the like. It is also possible to use mixtures, blends or alloys of these materials.

Particularly suited materials may be selected from SiO₂ crystalline and/or amorphous structure because these can be precipitated directly as spheres in a wet-chemical process. It is also possible, however, to use other materials known to the person skilled in the art.

According to the invention, it is possible, depending on the intended field of application, to select the material of the spheres and/or the material of the filled cavities/honeycombs as a function of the thermal load of the system.

The cavities/honeycombs in the color effect coating system, for example in accordance with a desired application, can be filled with one or more materials, selected from high temperature resistant oxides, high temperature resistant semi-conductor compounds, high temperature resistant sulfides and/or high temperature resistant elements.

According to an embodiment of the present invention, the material for the spheres and/or the material in the cavities/honeycombs in the case of low thermal stress (temperature up to 100° C.) can be a plastic, such as polystyrene (PS) or polymethyl methacrylate (PMMA). If the coating is subjected to high or higher thermal loads (temperatures starting at about 100° C.), the material may be selected, for example, from silicons, Teflon and the like.

In the case of extremely high thermal loads (temperatures above approximately 200° C.), the material can be selected from high temperature resistant oxides, such as SiO₂, TiO₂, BaTiO₃, Y₂O₃, ZnO, ZrO₂, SnO₂, Al₂O₃ and the like, high temperature resistant semi-conductor compounds, such as CdSe, CdTe, GaN, InP, GaP and the like, high temperature resistant sulfides, such as CdS, SnS₂, Sb₂S₃ and the like, or high temperature resistant elements, such as Si, Ge, W, Sn, Au, Ag, C and the like.

According to the present invention, it is also possible to combine spheres made of different materials. However, it is possible according to the invention if the spheres of one layer, preferably of a plurality of layers, particularly preferred of all layers in one composite, are made of the same material. It is also possible if one and the same material is used as the material, which is filled in the cavities/honeycombs, which material can differ from the material of the spheres.

According to an embodiment of the present invention, the (honeycomb) frame is made of a high temperature resistant material and the resulting cavities may or may not be filled with a high temperature resistant material.

The carrier substrate is not limited in detail according to the present invention, it is possible to use a glass or glass-ceramics substrate. It is also possible if a carrier substrate is used, on which the reflection is perceived well. This includes, for example, dark colored substrates, particularly black substrates. As far as the carrier substrate is concerned, of course it is selected accordingly in the desired thermal stability.

The thickness of the carrier substrate is not subject to any particular restrictions. By way of example, the carrier substrate may be used in a thickness from about 0.1 mm to about 100 mm.

The carrier substrate can be selected from a glass-ceramics cooktop or a glass-ceramics hot plate or parts thereof, refrigerating or freezing equipment fittings, particularly doors, shelves or parts thereof, and display or control elements that include or are made of glass or glass-ceramics, or parts thereof.

According to an embodiment of the present invention, additional measures may be taken, thus improving the adhesion of the spheres on the carrier substrate. For example, a special method for producing the spheres may be selected, which already results in improved adhesion of the spheres to the carrier substrate. A sol-gel method, for example, is such a method.

However, it is also possible to perform a post-treatment of the obtained sphere layer(s), which is (are) applied to the carrier. The measures can be selected from a) an annealing method; and/or b) an etching method.

The annealing method may be, for example, a hypercritical drying process.

Of course it is also possible to combine the measures described above in order to achieve the desired adhesion to the subsurface. It is particularly advantageous if the sphere layers are produced by a sol-gel method and one or both of the above-described post-treatment methods are carried out.

In addition to improved adhesion, a suitable post-treatment process and/or a suitable manufacturing method may also improve scratch resistance and optionally the temperature resistance of the color effect layer system.

According to a further aspect, the present invention also relates to a color effect layer system, including: a carrier substrate, selected from glass or glass-ceramics; and particles, including, respectively, at least one layer of spheres, particularly preferred at least 50 layers, more preferred 50 to 100 layers, including filled or not filled cavities/honeycombs, in the form of a crystal-like superstructure or an inverse crystal-like superstructure having a three-dimensional periodic or substantially periodic configuration in the order of magnitude of the wavelength of visible light, and sphere diameters and optionally cavity/honeycomb diameters in a very strict distribution, wherein the diameters of the particles are present in a very narrow distribution and the particles are embedded in the form of pigments in an oxidic matrix (a so-called “flow” or “glass flow”) and are applied as a composite on the top and/or bottom of the carrier substrate.

The layer(s) of spheres form(s) particles, which have the desired optical properties. In other words, the structures with a plurality of layers and/or cavities/honeycombs described above can be produced in the form of particles. These particles may then be applied to a carrier, particularly one made of glass or glass-ceramics.

The above explanations apply accordingly here.

It is also possible to use the coating described according to the present invention and/or the layer system according to the present invention particularly in the household field, when cooking, processing and cooling foods. Here, particularly thermal loads may play a role. This applies for the hot plates or cooktops of a stove, particularly a glass-ceramics cooktop or a glass-ceramics hot plate or parts thereon, refrigerating and freezing equipment fittings, particularly doors, shelves or parts thereof; display or control elements, including or made of glass or glass ceramics, or parts thereof, which have the coating according to the present invention across the entire surface or parts of the surface.

The present invention furthermore relates to a method for producing a color effect coating, wherein the coating described above is applied to a carrier substrate.

Alternatively, particles in the form of pigments may be embedded in an oxidic matrix (a so-called “flow”) and subsequently be applied as a composite to the top and/or bottom of a carrier substrate (for example glass-ceramics).

The coating can be produced using a sol-gel method. The sol-gel method here can be sol-gel infiltration.

The porous coating material producing a color effect according to the present invention, in the form of a crystal-like or inverse superstructure or a photonic crystal, can be produced in different ways.

A color effect coating according to the present invention is obtained, for example, in that spheres, such as polymer spheres, perform self-organizing or induced controlled processes in a dispersant, resulting in crystal-like superstructures through slow sedimentation. The lattice periodicity of the resultant crystal-like superstructures may be determined through the selection of the sphere size.

For color effect coatings, the crystal-like superstructures have a lattice periodicity in the refractive index profile in the range of the wavelength of the visible spectrum, meaning in the range of 380 nm≦d≦780 nm.

For the optical quality of the color effect coating, the strict periodicity in the refractive index profile or optionally a step of the refractive index and the high symmetry of the crystal-like superstructure and/or of the photonic crystal are crucial, so that only appropriately suited methods that meet these requirements can be used.

For example, hypercritical drying may be used, which is described in detail in WO 2004/024627, the disclosure content of which is hereby included to the full extent in the disclosure of the present invention.

This way, it is possible to produce particularly broad color effect layer systems and coatings based on photonic crystals, which in addition to their low defect rate and the associated color effects are also characterized by sufficiently high mechanical stability, allowing their use in thermally demanding fields.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a color effect coating on a substrate, including a porous material composite with equivalent spatial periodicity, wherein the cavities may optionally be filled with a material of low or high refractivity;

FIG. 2 is a color effect coating on a substrate, including two porous material composites with differing spatial periodicity, wherein the cavities may optionally be filled with a material of low or high refractivity;

FIGS. 3a-c show the production of crystal-like superstructures, for example from polymer spherules by way of hypercritical drying;

FIGS. 4a-c show the production of crystal-like superstructures made of highly refractive material by way of sol-gel infiltration of a template and hypercritical drying of the sol-gel infiltrate, wherein the (honeycomb) frame may be made of a high temperature resistant material and the resulting cavities may or may not be filled with a high temperature resistant material; and

FIG. 5 shows a crystal-like superstructure, wherein between the spheres forming the superstructure neck-shaped material connections are formed to provide mechanical stability.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

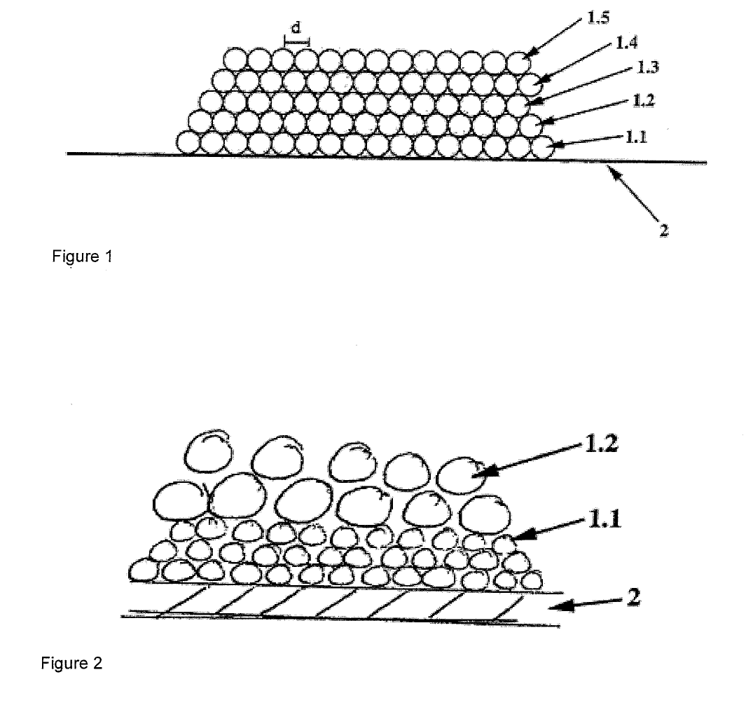

Referring now to the drawings, and more particularly to FIG. 1, there is shown a color effect coating according to the present invention on a substrate 2, particularly a glass or glass-ceramics substrate, including five porous, crystal-like organized composites 1.1 to 1.5, which do not differ in their lattice periodicity. The lattice periodicity of the refractive index should be selected such that the maximum of the first refraction order for reflected light of at least one visible wavelength is in the angle range between 0 and 180 degrees. The angle here is defined such that 0 degrees means precise back-scattering in exactly the opposite direction of the incident light beam and 90 degrees means scattering at a right angle to the incident light.

Light with a wavelength in the range of visible light, meaning between 380 nm and 780 nm, is being reflected. The sphere sizes are subject to extremely narrow distribution. The resultant system offers improved mechanical stability compared to the known related art, without the need to resort to the necks, for example, as additional connections between the spheres. A color effect coating according to the invention, however, may also be formed by a porous composite with two lattice periodicities or by a plurality of composites with more than two different lattice perioditicies. The cavities may optionally be filled with a material with low or high refractivity.

FIG. 2 shows a color effect coating on a glass or glass ceramics substrate 2 with two porous, crystal-like organized composites 1.1, 1.2, which differ in their lattice periodicity. Composite 1.1 includes 3 layers of spheres with the same periodicity, the composite 1.2 above that includes two layers of spheres with the same periodicity. Both lattice periodicities of the refractive index are again selected such that only light with a wavelength in the range of visible light, meaning between 380 nm and 780 nm, is being reflected. The sphere sizes of the two composites 1.1 and 1.2 were adjusted within a very narrow distribution. Since each of the composites reflects selective wavelengths, a mixed color impression is created for the observer as a function of the angle, which impression is characterized at the same time by an opalescent effect. The cavities may optionally be filled with a material with low or high refractivity.

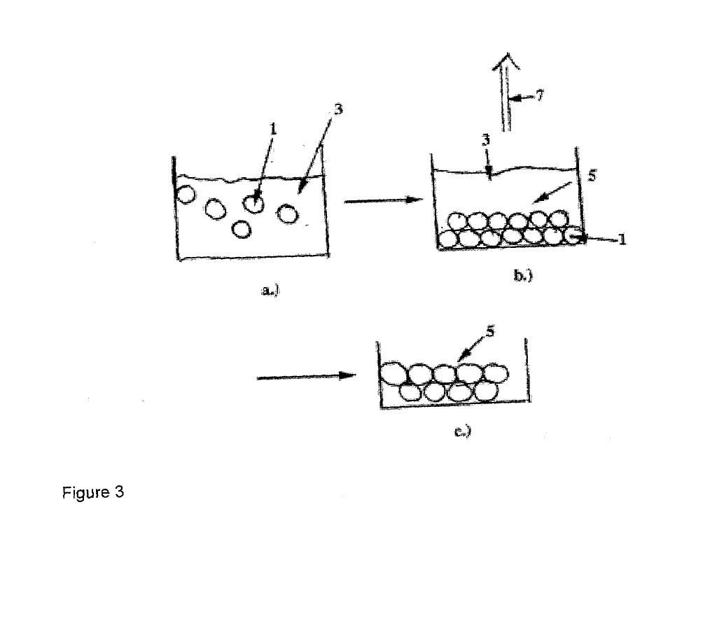

FIGS. 3a to 3c show the production of a crystal-like superstructure through the addition of spheres 1, preferably spherules with dimensions selected in the range of 10 nm to 10 μm, with an extremely narrow distribution regarding the sphere sizes, in a dispersant 3 and the removal of the dispersant. The spheres may be polymer spherules or spherules made of other organic or inorganic materials, such as plastic or glass. According to FIG. 3a, the spheres are distributed irregularly in the solution 3 with extremely narrow size distribution. Through sedimentation and self-organization or induced, controlled organization, the spheres align in crystal-like, regular superstructures 5. This is shown in FIG. 3b. The dispersant also present in FIG. 3b can be removed by hypercritical drying. As a result, the solid 5 shown according to FIG. 3c is obtained, which has a crystal-like superstructure. The solid 5 as such may serve as the photonic crystal, for example in the form of polymer spherules, or it may serve as a template for highly refractive materials.

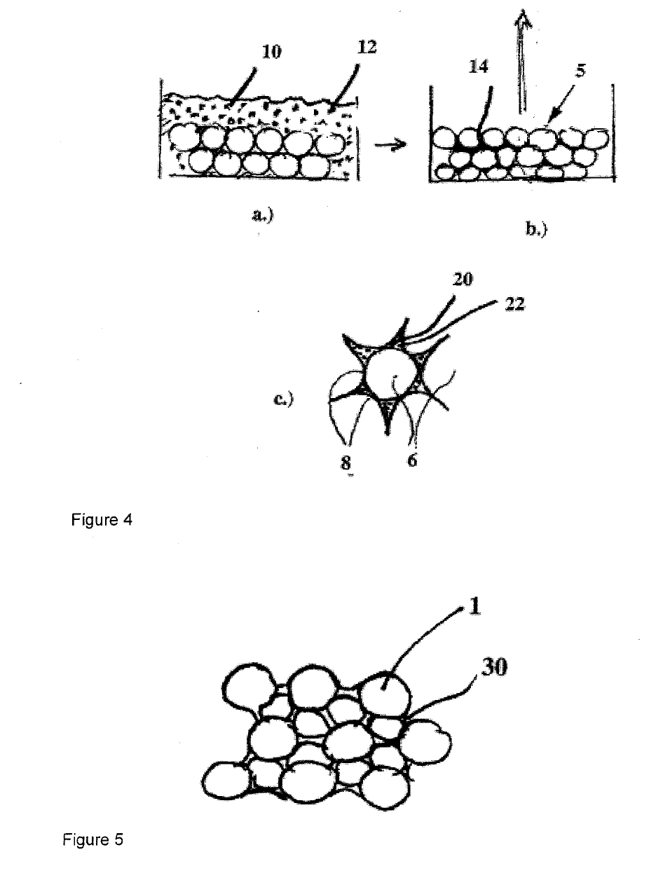

If a polymer solid with a crystal-like superstructure is used as the template, the photonic crystal may be produced from highly refractive material, as is shown according to FIGS. 4a-4c, for example by sol-gel infiltration with a highly refractive material. According to FIG. 4a, for example, the polymer solid with a crystal-like superstructure is placed in a colloidal solution and/or a sol 10. The colloidal solution includes spheres 12 with a size ranging between 5×10⁻¹⁰ and 2×10⁻¹⁰ m, which agglomerate and form a gel structure.

In the spaces 14 of the polymer solid 5, which forms the template for the highly refractive material, a gel structure is formed. According to an embodiment of the present invention, the gel structure may be dried hypercritically. The hypercritically dried structure is shown in FIG. 4c. The dried highly refractive material has been assigned reference numeral 20, the microstructure resulting due to the micro-porosities has been assigned numeral 22, and the pores with 6, which are separated by walls 8, which in turn are part of the microstructure 22. So as to increase the difference in refractive indices, the spheres 1 of the template may be drawn off, for example from a solid made of polymer spherules as the template by baking them out.

FIG. 5 shows in a schematically simplified manner a mechanical strengthening of the crystal-like superstructure due to the formation of neck-shaped material connections 30 between the spheres 1. The disadvantage of such a structure is that generally the growth of the same cannot be controlled with sufficient precision, resulting in a deviation from the symmetrical structure and a distortion of the lattice, which reduces the color effects of the coating.

As a result, the present invention provides mechanically stable, particularly also thermally stable coatings and/or layer systems with highly organized superstructure materials, wherein contrary to the state of the art no necks are required to stabilize the superstructure and nevertheless the desired color effects are achieved to a high degree.

### Example of Embodiment

SiO₂ aerogels were produced as templates for forming an inverse crystal-like superstructure. To do so, a gel made of tetramethyl orthosilicate Si(OCH₃)₄ (TMOS) was produced in the conventional manner and dried hypercritically according to the following description. First, the pressure P was drastically increased at constant temperature, in the present case of TMOS for the production of SiO₂ aerogels to about 80 bar. Then, the temperature was raised to about 270° C., while the pressure was kept constant. Under these conditions, the fluid can be pushed or drawn out of the gel structure without causing the gel structure to collapse or shrink, because such process control always occurs above the critical temperature T_{K} and only a liquid or gaseous phase is present. The removal of the liquid or gaseous phase is carried out while lowering the pressure to atmospheric pressure. When the atmospheric pressure has been reached, the temperature is lowered to room temperature.

The solid that is obtained serves as a template for the production of the photonic material. The color effect layer system was produced by sol-gel infiltration. A color effect coating according to the present invention was obtained, which combines sufficiently high mechanical stability with high color brilliance.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A color effect layer system, comprising:
a carrier substrate comprised of one of a glass and a glass-ceramic; and
at least one layer of a plurality of spheres, said at least one layer of said plurality of spheres including a plurality of one of filled and unfilled cavities and being in a form of a porous material composite of one of a crystal-like superstructure and an inverse crystal-like superstructure having one of a three-dimensional periodic configuration and a three-dimensional substantially periodic configuration in an order of magnitude of a wavelength of visible light, said plurality of spheres including a plurality of sphere diameters which are present in a very narrow distribution.

2. The color effect layer system of claim 1, wherein said at least one layer of said plurality of spheres includes at least 50 layers.

3. The color effect layer system of claim 1, wherein said at least one layer of said plurality of spheres includes 50 to 100 layers.

4. The color effect layer system of claim 1, wherein said plurality of cavities includes a plurality of cavity diameters which are present in a very narrow distribution.

5. The color effect layer system according to claim 1, wherein a material of said plurality of spheres is the same in at least one said layer.

6. The color effect layer system according to claim 1, wherein at least one said layer of said plurality of spheres includes a plurality of layers, a material of said plurality of spheres being the same in at least two of said plurality of layers.

7. The color effect layer system according to claim 1, wherein at least one said layer of said plurality of spheres includes a plurality of layers, a material of said plurality of spheres being the same in all of said plurality of layers.

8. The color effect layer system according to claim 1, wherein at least one of a material of said plurality of spheres and a material that is present in said plurality of cavities includes at least one of a high temperature resistant oxide, a high temperature resistant semi-conductor compound, a high temperature resistant sulfide, and a high temperature resistant element.

9. The color effect layer system according to claim 8, wherein said high temperature resistant oxide is at least one of SiO₂, TiO2, BaTiO3, Y₂O₃, ZnO, ZrO₂, SnO₂, and Al₂O₃, said high temperature resistant semi-conductor compound being at least one of CdSe, CdTe, GaN, InP, and GaP, said high temperature resistant sulfide being at least one of CdS, SnS₂, and Sb₂S₃, and said high temperature resistant element being at least one of Si, Ge, W, Sn, Au, Ag, and C.

10. The color effect layer system according to claim 1, wherein said plurality of spheres includes a sphere radius, said distribution being such that a standard deviation of said sphere radius divided by a mean value of said sphere radius Δr/ r̅=\sqrt{r̅²̅= r̅²}/ r̅ (the dash denoting that a mean value is formed) is <0.1.

11. The color effect layer system according to claim 1, wherein said plurality of spheres includes a sphere radius, said distribution being such that a standard deviation of said sphere radius divided by a mean value of said sphere radius Δr/ r̅=\sqrt{r̅²̅= r̅²}/ r̅ (the dash denoting that a mean value is formed) is <0.03.

12. The color effect layer system according to claim 1, wherein said plurality of spheres includes a sphere radius, said distribution being such that a standard deviation of said sphere radius divided by a mean value of said sphere radius Δr/ r̅=\sqrt{r̅²̅= r̅²}/ r̅ (the dash denoting that a mean value is formed) is <0.001.

13. The color effect layer system according to claim 1, wherein said plurality of spheres have a size in a range of 10 nm to 10 μm.

14. The color effect layer system according to claim 1, wherein at least one said layer of said plurality of spheres includes up to about 500 layers of said plurality of spheres with one of said periodic and said substantially periodic configuration.

15. The color effect layer system according to claim 1, wherein at least one said layer of said plurality of spheres includes at least 5 to up to at least 200 layers of said plurality of spheres with one of said periodic and said substantially periodic configuration.

16. The color effect layer system according to claim 1, wherein at least one said layer of said plurality of spheres includes at least 10 to up to at least 100 layers of said plurality of spheres with one of said periodic and said substantially periodic configuration.

17. The color effect layer system according to claim 1, wherein a plurality of characteristic dimensions of different periodically arranged said plurality of cavities of one of said crystal-like and said inverse crystal-like superstructure largely agree with each other and are within a very narrow distribution, a lattice periodicity of a refractive index being such that a maximum of a first refractive order for reflected light of at least one visible wavelength is in an angle range between 0 and 180 degrees.

18. The color effect layer system according to claim 1, wherein at least one said layer of said plurality of spheres of one of said crystal-like superstructure and said inverse crystal-like superstructure with one of said periodic and said substantially periodic configuration has a periodic distance d in a range of 100 nm≦d≦3000 nm.

19. The color effect layer system according to claim 1, wherein at least one said layer of said plurality of spheres of one of said crystal-like superstructure and said inverse crystal-like superstructure with one of said periodic and said substantially periodic configuration has a periodic distance d in a range of 300 nm≦d≦1000 nm.

20. The color effect layer system according to claim 1, wherein the color effect layer system includes a plurality of loose structures configured for increasing a plurality of optical effects of the color effect layer system, said plurality of loose structures including one of a plurality of structures which has a primary volume percentage having a medium with a low refractive index, a plurality of structures which has a distance d of said plurality of spheres in a range of two times a sphere radius to five times said sphere radius, and a plurality of structures which has a primary volume percentage having a medium with a high refractive index.

21. The color effect layer system according to claim 20, wherein said medium with said low refractive index is air.

22. The color effect layer system according to claim 20, wherein said medium with said high refractive index includes at least one of TiO₂, ZnS, ZrO₂, Ge, Si, GaP, Sb2S3, SnS2, and CdS.

23. The color effect layer system according to claim 1, wherein a difference between a refractive index of a material of said plurality of spheres and a refractive index of a material of said plurality of one of filled and unfilled cavities is as large as possible.

24. The color effect layer system according to claim 1, wherein at least one of a material of said plurality of spheres and a material in said plurality of cavities includes one of plastic, amorphous material, and glass.

25. The color effect layer system according to claim 24, wherein said plastic includes at least one of polystyrene, polymethyl methacrylate, silicon, and Teflon.

26. The color effect layer system according to claim 24, wherein at least one of said material of said plurality of spheres and said material in said plurality of cavities includes one of amorphous SiO₂ and SiO₂ glass.

27. The color effect layer system according to claim 1, wherein at least one of a material of said plurality of spheres and a material in said plurality of cavities varies dependent on a thermal load of said composite.

28. The color effect layer system according to claim 27, wherein at least one of said material of said plurality of spheres and said material in said plurality of cavities in a case of a low thermal load includes a plastic.

29. The color effect layer system according to claim 28, wherein said plastic includes one of polystyrene and polymethyl methacrylate.

30. The color effect layer system according to claim 27, wherein at least one of said material of said plurality of spheres and said material in said plurality of cavities in a case of a high thermal load includes one of a silicon and Teflon.

31. The color effect layer system according to claim 27, wherein at least one of said material of said plurality of spheres and said material in said plurality of cavities in a case of an extremely high thermal load includes at least one of a high temperature resistant oxide, a high temperature resistant semi-conductor compound, a high temperature resistant sulfide, and a high temperature resistant element.

32. The color effect layer system according to claim 31, wherein said high temperature resistant oxide includes at least one of SiO₂, TiO₂, BaTiO₃, Y₂O₃, ZnO, ZrO₂, SnO₂, and Al₂O₃,

33. The color effect layer system according to claim 31, wherein said high temperature resistant semi-conductor compound includes at least one of CdSe, CdTe, GaN, InP, and GaP,

34. The color effect layer system according to claim 31, wherein said high temperature resistant sulfide includes at least one of CdS, SnS₂, and Sb₂S₃.

35. The color effect layer system according to claim 31, wherein said high temperature resistant element includes at least one of Si, Ge, W, Sn, Au, Ag, and C.

36. The color effect layer system according to claim 1, wherein said carrier substrate is configured for making possible a perception of a plurality of optical properties.

37. The color effect layer system according to claim 36, wherein said carrier substrate includes a dark colored carrier substrate.

38. The color effect layer system according to claim 36, wherein said carrier substrate includes a black carrier substrate.

39. The color effect layer system according to claim 36, wherein said carrier substrate includes one of a glass-ceramic cooktop, a glass-ceramic hot plate, and a plurality of parts of at least one of said glass-ceramic cooktop and said glass-ceramic hot plate.

40. The color effect layer system according to claim 36, wherein said carrier substrate includes one of a plurality of refrigerating furniture fittings, a plurality of freezing furniture fittings, and a plurality of parts of at least one of said plurality of refrigerating furniture fittings and said plurality of freezing furniture fittings.

41. The color effect layer system according to claim 40, wherein one of said plurality of refrigerating furniture fittings and said plurality of freezing furniture fittings includes at least one of a plurality of doors and a plurality of shelves.

42. The color effect layer system according to claim 36, wherein said carrier substrate includes one of a plurality of display elements and a plurality of control elements, said one of said plurality of display elements and said plurality of control elements including one of said glass, said glass ceramic, and a plurality of parts of at least one of said glass and said glass ceramic.

43. The color effect layer system according to claim 1, wherein said crystal-like superstructure substantially has no neck-shaped material connections between said plurality of spheres forming said crystal-like superstructure having one of said three-dimensional periodic configuration and said three-dimensional substantially periodic configuration.

44. The color effect layer system according to claim 1, further comprising a plurality of walls and a plurality of pores, wherein said inverse crystal-like superstructure substantially has no inverse neck-shaped passages in said plurality of walls between said plurality of pores.

45. A color effect layer system, comprising:
a carrier substrate comprised of one of a glass and a glass-ceramic and including at least one of a top and a bottom;
an oxidic matrix; and
a plurality of particles including respectively at least one layer of a plurality of spheres, said at least one layer of said plurality of spheres including a plurality of one of filled and unfilled cavities and being in a form of a porous material composite of one of a crystal-like superstructure and an inverse crystal-like superstructure having one of a three-dimensional periodic configuration and a three-dimensional substantially periodic configuration in an order of magnitude of a wavelength of visible light, said plurality of spheres including a plurality of sphere diameters which are present in a very narrow distribution, said plurality of particles including a plurality of particle diameters which are present in a very narrow distribution, said plurality of particles being in a form of a plurality of pigments in said oxidic matrix, said plurality of particles being a composite coupled with at least one of said top and said bottom of said carrier substrate.

46. The color effect layer system of claim 45, wherein said at least one layer of said plurality of spheres includes at least 50 layers.

47. The color effect layer system of claim 45, wherein said at least one layer of said plurality of spheres includes 50 to 100 layers.

48. The color effect layer system of claim 45, wherein said plurality of cavities includes a plurality of cavity diameters which are present in a very narrow distribution.

49. A color effect coating for one of a glass and a glass-ceramic substrate, said color effect coating comprising:
at least one layer of a plurality of spheres, said at least one layer of said plurality of spheres including a plurality of one of filled and unfilled cavities and being in a form of a porous material composite of one of a crystal-like superstructure and an inverse crystal-like superstructure having one of a three-dimensional periodic configuration and a three-dimensional substantially periodic configuration in an order of magnitude of a wavelength of visible light, said plurality of spheres including a plurality of sphere diameters which are present in a very narrow distribution.

50. The color effect coating of claim 49, wherein said at least one layer of said plurality of spheres includes at least 50 layers.

51. The color effect coating of claim 49, wherein said at least one layer of said plurality of spheres includes 50 to 100 layers.

52. The color effect coating of claim 49, wherein said plurality of cavities includes a plurality of cavity diameters which are present in a very narrow distribution.

53. The color effect coating according to claim 49, wherein a material of said plurality of spheres is the same in at least one said layer.

54. The color effect coating according to claim 49, wherein at least one said layer of said plurality of spheres includes a plurality of layers, a material of said plurality of spheres being the same in at least two of said plurality of layers.

55. The color effect coating according to claim 49, wherein at least one said layer of said plurality of spheres includes a plurality of layers, a material of said plurality of spheres being the same in all of said plurality of layers.

56. The color effect coating according to claim 49, wherein at least one of a material of said plurality of spheres and a material that is present in said plurality of cavities includes at least one of a high temperature resistant oxide, a high temperature resistant semi-conductor compound, a high temperature resistant sulfide, and a high temperature resistant element.

57. The color effect coating according to claim 56, wherein said high temperature resistant oxide is at least one of SiO₂, TiO2, BaTiO3, Y₂O₃, ZnO, ZrO₂, SnO₂, and Al₂O₃, said high temperature resistant semi-conductor compound being at least one of CdSe, CdTe, GaN, InP, and GaP, said high temperature resistant sulfide being at least one of CdS, SnS₂, and Sb₂S₃, and said high temperature resistant element being at least one of Si, Ge, W, Sn, Au, Ag, and C.

58. A color effect coating according to claim 49, wherein said plurality of spheres includes a sphere radius, said distribution being such that a standard deviation of said sphere radius divided by a mean value of said sphere radius Δr/ r̅=\sqrt{r̅²̅= r̅²}/ r̅ (the dash denoting that a mean value is formed) is <0.1.

59. A color effect coating according to claim 49, wherein said plurality of spheres includes a sphere radius, said distribution being such that a standard deviation of said sphere radius divided by a mean value of said sphere radius Δr/ r̅=\sqrt{r̅²̅= r̅²}/ r̅ (the dash denoting that a mean value is formed) is <0.03.

60. A color effect coating according to claim 49, wherein said plurality of spheres includes a sphere radius, said distribution being such that a standard deviation of said sphere radius divided by a mean value of said sphere radius Δr/ r̅=\sqrt{r̅²̅= r̅²}/ r̅ (the dash denoting that a mean value is formed) is <0.001.

61. A color effect coating according to claim 49, wherein said plurality of spheres have a size in a range of 10 nm to 10 μm.

62. A color effect coating according to claim 49, wherein at least one said layer of said plurality of spheres includes up to about 500 layers of said plurality of spheres with one of said periodic and said substantially periodic configuration.

63. A color effect coating according to claim 49, wherein at least one said layer of said plurality of spheres includes at least 5 to at least 200 layers of said plurality of spheres with one of said periodic and said substantially periodic configuration.

64. A color effect coating according to claim 49, wherein at least one said layer of said plurality of spheres includes at least 10 to at least 100 layers of said plurality of spheres with one of said periodic and said substantially periodic configuration.

65. A color effect coating according to claim 49, wherein a plurality of characteristic dimensions of different periodically arranged said plurality of cavities of one of said crystal-like and said inverse crystal-like superstructure largely agree with each other and are within a very narrow distribution, a lattice periodicity of a refractive index being such that a maximum of a first refractive order for reflected light of at least one visible wavelength is in an angle range between 0 and 180 degrees.

66. A color effect coating according to claim 49, wherein at least one said layer of said plurality of spheres of one of said crystal-like superstructure and said inverse crystal-like superstructure with one of said periodic and said substantially periodic configuration has a periodic distance d in a range of 100 nm≦d≦3000 nm.

67. The color effect layer system according to claim 49, wherein at least one said layer of said plurality of spheres of one of said crystal-like superstructure and said inverse crystal-like superstructure with one of said periodic and said substantially periodic configuration has a periodic distance d in a range of 300 nm≦d≦1000 nm.

68. A color effect coating according to claim 49, wherein the color effect layer system includes a plurality of loose structures configured for increasing a plurality of optical effects of the color effect layer system, said plurality of loose structures including one of a plurality of structures which has a primary volume percentage having a medium with a low refractive index, a plurality of structures which has a distance d of said plurality of spheres in a range of two times a sphere radius to five times said sphere radius, and a plurality of structures which has a primary volume percentage having a medium with a high refractive index.

69. The color effect coating according to claim 68, wherein said medium with said low refractive index is air.

70. The color effect coating according to claim 68, wherein said medium with said high refractive index includes at least one of TiO₂, ZnS, ZrO₂, Ge, Si, GaP, Sb2S3, SnS2, and CdS.

71. A color effect coating according to claim 49, wherein a difference between a refractive index of a material of said plurality of spheres and a refractive index of a material of said plurality of one of filled and unfilled cavities is as large as possible.

72. A color effect coating according to claim 49, wherein at least one of a material of said plurality of spheres and a material in said plurality of cavities includes one of plastic, amorphous material, and glass.

73. The color effect coating according to claim 72, wherein said plastic includes at least one of polystyrene, polymethyl methacrylate, silicon, and Teflon.

74. The color effect coating according to claim 72, wherein at least one of said material of said plurality of spheres and said material in said plurality of cavities includes one of amorphous SiO₂ and SiO₂ glass.

75. A color effect coating according to claim 49, wherein at least one of a material of said plurality of spheres and a material in said plurality of cavities varies dependent on a thermal load of the coating.

76. The color effect coating according to claim 75, wherein at least one of said material of said plurality of spheres and said material in said plurality of cavities in a case of a low thermal load includes a plastic.

77. The color effect layer system according to claim 76, wherein said plastic includes one of polystyrene and polymethyl methacrylate.

78. The color effect coating according to claim 75, wherein at least one of said material of said plurality of spheres and said material in said plurality of cavities in a case of a high thermal load includes one of a silicon and Teflon.

79. The color effect coating according to claim 75, wherein at least one of said material of said plurality of spheres and said material in said plurality of cavities in a case of an extremely high thermal load includes at least one of a high temperature resistant oxide, a high temperature resistant semi-conductor compound, a high temperature resistant sulfide, and a high temperature resistant element.

80. The color effect coating according to claim 79, wherein said high temperature resistant oxide includes at least one of SiO₂, TiO₂, BaTiO₃, Y₂O₃, ZnO, ZrO₂, SnO₂, and Al₃,

81. The color effect coating according to claim 79, wherein said high temperature resistant semi-conductor compound includes at least one of CdSe, CdTe, GaN, InP, and GaP,

82. The color effect coating according to claim 79, wherein said high temperature resistant sulfide includes at least one of CdS, SnS₂, and Sb₂S₃.

83. The color effect coating according to claim 79, wherein said high temperature resistant element includes at least one of Si, Ge, W, Sn, Au, Ag, and C.

84. A color effect coating according to claim 49, wherein said crystal-like superstructure substantially has no neck-shaped material connections between said plurality of spheres forming said crystal-like superstructure having one of said three-dimensional periodic configuration and said three-dimensional substantially periodic configuration.

85. A color effect coating according to claim 49, further comprising a plurality of walls and a plurality of pores, wherein said inverse crystal-like superstructure substantially has no inverse neck-shaped passages in said plurality of walls between said plurality of pores.

86. A color effect layer system, comprising:
an oxidic matrix; and
a plurality of particles including respectively at least one layer of a plurality of spheres, said at least one layer of said plurality of spheres including a plurality of one of filled and unfilled cavities and being in a form of a porous material composite of one of a crystal-like superstructure and an inverse crystal-like superstructure having one of a three-dimensional periodic configuration and a three-dimensional substantially periodic configuration in an order of magnitude of a wavelength of visible light, said plurality of spheres including a plurality of sphere diameters which are present in a very narrow distribution, said plurality of particles including a plurality of particle diameters which are present in a very narrow distribution, said plurality of particles being in a form of a pigment in an oxidic matrix in a form of a coating.

87. The color effect layer system of claim 86, wherein said at least one layer of said plurality of spheres includes at least 50 layers.

88. The color effect layer system of claim 86, wherein said at least one layer of said plurality of spheres includes 50 to 100 layers.

89. The color effect layer system of claim 86, wherein said plurality of cavities includes a plurality of cavity diameters which are present in a very narrow distribution.

90. A method for producing a color effect coating, said method comprising the steps of:
providing at least one layer of a plurality of spheres, said at least one layer of said plurality of spheres including a plurality of one of filled and unfilled cavities and being in a form of a porous material composite of one of a crystal-like superstructure and an inverse crystal-like superstructure having one of a three-dimensional periodic configuration and a three-dimensional substantially periodic configuration in an order of magnitude of a wavelength of visible light, said plurality of spheres including a plurality of sphere diameters which are present in a very narrow distribution; and
applying said at least one layer of said plurality of spheres to a carrier substrate.

91. The method of claim 90, wherein said at least one layer of said plurality of spheres includes at least 50 layers.

92. The method of claim 90, wherein said at least one layer of said plurality of spheres includes 50 to 100 layers.

93. The method of claim 90, wherein said plurality of cavities includes a plurality of cavity diameters which are present in a very narrow distribution.

94. The method according to claim 90, wherein a material of said plurality of spheres is the same in at least one said layer.

95. The method according to claim 90, wherein at least one said layer of said plurality of spheres includes a plurality of layers, a material of said plurality of spheres being the same in at least two of said plurality of layers.

96. The method according to claim 90, wherein at least one said layer of said plurality of spheres includes a plurality of layers, a material of said plurality of spheres being the same in all of said plurality of layers.

97. The method according to claim 90, wherein at least one of a material of said plurality of spheres and a material that is present in said plurality of cavities includes at least one of a high temperature resistant oxide, a high temperature resistant semi-conductor compound, a high temperature resistant sulfide, and a high temperature resistant element.

98. The method according to claim 97, wherein said high temperature resistant oxide is at least one of SiO₂, TiO2, BaTiO3, Y₂O₃, ZnO, ZrO₂, SnO₂, and Al₂O₃, said high temperature resistant semi-conductor compound being at least one of CdSe, CdTe, GaN, InP, and GaP, said high temperature resistant sulfide being at least one of CdS, SnS₂, and Sb₂S₃, and said high temperature resistant element being at least one of Si, Ge, W, Sn, Au, Ag, and C.

99. The method according to claim 90, wherein the color effect coating is produced using a sol-gel method.

100. The method according to claim 99, wherein the color effect coating is produced by sol-gel infiltration.

101. The method according to claims 99, wherein the color effect coating is produced by hypercritical drying.

102. The method according to claims 90, wherein said plurality of spheres have a size in a range of 10 nm to 10 μm.

103. The method according to claim 90, wherein the coating is applied to said carrier substrate by homogeneous deposition.

104. The method according to claim 90, wherein the coating is applied to said carrier substrate by a screen-printing method.

105. The method according to claim 90, wherein the color effect coating on said carrier substrate is subjected to a post-treatment step including at least one of an annealing method and an etching method in order to increase an adhesion, a scratch resistance, and a temperature stability of the coating.

106. A method for producing a color effect coating, said method comprising the steps of:
providing a plurality of particles including respectively at least one layer of a plurality of spheres, said at least one layer of said plurality of spheres including a plurality of one of filled and unfilled cavities and being in a form of a porous material composite of one of a crystal-like superstructure and an inverse crystal-like superstructure having one of a three-dimensional periodic configuration and a three-dimensional substantially periodic configuration in an order of magnitude of a wavelength of visible light, said plurality of spheres including a plurality of sphere diameters which are present in a very narrow distribution, said plurality of particles including a plurality of particle diameters which are present in a very narrow distribution, embedding said plurality of particles in a form of a plurality of pigments in an oxidic matrix; and
applying said plurality of particles as a composite on at least one of a top and a bottom of a carrier substrate.

107. The method according to claim 106, wherein said at least one layer of said plurality of spheres includes at least 50 layers.

108. The method according to claim 106, wherein said at least one layer of said plurality of spheres includes 50 to 100 layers.

109. The method according to claim 106, wherein said plurality of cavities includes a plurality of cavity diameters which are present in a very narrow distribution.

110. A method of using a color effect coating, said method comprising the steps of:
providing the color effect coating including at least one layer of a plurality of spheres, said at least one layer of said plurality of spheres including a plurality of one of filled and unfilled cavities and being in a form of a porous material composite of one of a crystal-like superstructure and an inverse crystal-like superstructure having one of a three-dimensional periodic configuration and a three-dimensional substantially periodic configuration in an order of magnitude of a wavelength of visible light, said plurality of spheres including a plurality of sphere diameters which are present in a very narrow distribution; and
using the color effect coating on one of: a) one of a glass-ceramics cooktop, a glass-ceramics hot plate, and a plurality of parts of at least one of said glass-ceramics cooktop and said glass-ceramics hot plate, b) one of a plurality of refrigerating equipment fittings, a plurality of freezing equipment fittings, and a plurality of parts of at least one of said plurality of refrigerating equipment fittings and said plurality of freezing equipment fittings including a plurality of doors and a plurality of shelves, and c) one of a plurality of display elements and a plurality of control elements including one of glass, a plurality of glass ceramics, and a plurality of parts of at least one of said glass and said plurality of glass ceramics.

111. The glass-ceramics cooktop of claim 110, wherein said at least one layer of said plurality of spheres includes at least 50 layers.

112. The glass-ceramics cooktop of claim 110, wherein said at least one layer of said plurality of spheres includes 50 to 100 layers.

113. The glass-ceramics cooktop of claim 110, wherein said plurality of cavities includes a plurality of cavity diameters which are present in a very narrow distribution.

114. A glass-ceramics cooktop, comprising:
a color effect coating including at least one layer of a plurality of spheres, said at least one layer of said plurality of spheres including a plurality of one of filled and unfilled cavities and being in a form of a porous material composite of one of a crystal-like superstructure and an inverse crystal-like superstructure having one of a three-dimensional periodic configuration and a three-dimensional substantially periodic configuration in an order of magnitude of a wavelength of visible light, said plurality of spheres including a plurality of sphere diameters which are present in a very narrow distribution.

115. The glass-ceramics cooktop of claim 114, wherein said at least one layer of said plurality of spheres includes at least 50 layers.

116. The glass-ceramics cooktop of claim 114, wherein said at least one layer of said plurality of spheres includes 50 to 100 layers.

117. The glass-ceramics cooktop of claim 114, wherein said plurality of cavities includes a plurality of cavity diameters which are present in a very narrow distribution.

118. A glass-ceramics hot plate, comprising:
a color effect coating including at least one layer of a plurality of spheres, said at least one layer of said plurality of spheres including a plurality of one of filled and unfilled cavities and being in a form of a porous material composite of one of a crystal-like superstructure and an inverse crystal-like superstructure having one of a three-dimensional periodic configuration and a three-dimensional substantially periodic configuration in an order of magnitude of a wavelength of visible light, said plurality of spheres including a plurality of sphere diameters which are present in a very narrow distribution.

119. The glass-ceramics hot plate of claim 118, wherein said at least one layer of said plurality of spheres includes at least 50 layers.

120. The glass-ceramics hot plate of claim 118, wherein said at least one layer of said plurality of spheres includes 50 to 100 layers.

121. The glass-ceramics hot plate of claim 118, wherein said plurality of cavities includes a plurality of cavity diameters which are present in a very narrow distribution.

122. A refrigerating equipment fitting, comprising:
a color effect coating including at least one layer of a plurality of spheres, said at least one layer of said plurality of spheres including a plurality of one of filled and unfilled cavities and being in a form of a porous material composite of one of a crystal-like superstructure and an inverse crystal-like superstructure having one of a three-dimensional periodic configuration and a three-dimensional substantially periodic configuration in an order of magnitude of a wavelength of visible light, said plurality of spheres including a plurality of sphere diameters which are present in a very narrow distribution.

123. The refrigerating equipment fitting of claim 122, wherein said at least one layer of said plurality of spheres includes at least 50 layers.

124. The refrigerating equipment fitting of claim 122, wherein said at least one layer of said plurality of spheres includes 50 to 100 layers.

125. The refrigerating equipment fitting of claim 122, wherein said plurality of cavities includes a plurality of cavity diameters which are present in a very narrow distribution.

126. The refrigerating equipment fitting of claim 122, wherein the refrigerating equipment fitting includes one of a door, a shelf, and at least one of a plurality of parts of said door and said shelf.

127. A freezing equipment fitting, comprising:
a color effect coating including at least one layer of a plurality of spheres, said at least one layer of said plurality of spheres including a plurality of one of filled and unfilled cavities and being in a form of a porous material composite of one of a crystal-like superstructure and an inverse crystal-like superstructure having one of a three-dimensional periodic configuration and a three-dimensional substantially periodic configuration in an order of magnitude of a wavelength of visible light, said plurality of spheres including a plurality of sphere diameters which are present in a very narrow distribution.

128. The freezing equipment fitting of claim 127, wherein said at least one layer of said plurality of spheres includes at least 50 layers.

129. The freezing equipment fitting of claim 127, wherein said at least one layer of said plurality of spheres includes 50 to 100 layers.

130. The freezing equipment fitting of claim 127, wherein said plurality of cavities includes a plurality of cavity diameters which are present in a very narrow distribution.

131. The freezing equipment fitting of claim 127, wherein the freezing equipment fitting includes one of a door, a shelf, and at least one of a plurality of parts of said door and said shelf.

132. A display element, comprising:
a color effect coating including at least one layer of a plurality of spheres, said at least one layer of said plurality of spheres including a plurality of one of filled and unfilled cavities and being in a form of a porous material composite of one of a crystal-like superstructure and an inverse crystal-like superstructure having one of a three-dimensional periodic configuration and a three-dimensional substantially periodic configuration in an order of magnitude of a wavelength of visible light, said plurality of spheres including a plurality of sphere diameters which are present in a very narrow distribution, the display element including one of glass, a plurality of glass ceramics, and a plurality of parts of at least one of said glass and said plurality of glass ceramics.

133. The display element of claim 132, wherein said at least one layer of said plurality of spheres includes at least 50 layers.

134. The display element of claim 132, wherein said at least one layer of said plurality of spheres includes 50 to 100 layers.

135. The display element of claim 132, wherein said plurality of cavities includes a plurality of cavity diameters which are present in a very narrow distribution.

136. A control element, comprising:
a color effect coating including at least one layer of a plurality of spheres, said at least one layer of said plurality of spheres including a plurality of one of filled and unfilled cavities and being in a form of a porous material composite of one of a crystal-like superstructure and an inverse crystal-like superstructure having one of a three-dimensional periodic configuration and a three-dimensional substantially periodic configuration in an order of magnitude of a wavelength of visible light, said plurality of spheres including a plurality of sphere diameters which are present in a very narrow distribution, the control element including one of glass, a plurality of glass ceramics, and a plurality of parts of at least one of said glass and said plurality of glass ceramics.

137. The display element of claim 136, wherein said at least one layer of said plurality of spheres includes at least 50 layers.

138. The display element of claim 136, wherein said at least one layer of said plurality of spheres includes 50 to 100 layers.

139. The display element of claim 136, wherein said plurality of cavities includes a plurality of cavity diameters which are present in a very narrow distribution.
